(19) United States
(12) Patent Application Publication
(10) Pub. No.: US 2015/0357739 A1
(43) Pub. Date: Dec. 10, 2015

(54) POWER CONNECTOR

(71) Applicant: KALAS MANUFACTURING, INC., Lancaster, PA (US)

(72) Inventors: Thykadavil CHERIAN, Philadelphia, PA (US); Anthony J. HATT, Ephrata, PA (US)

(21) Appl. No.: 14/734,120

(22) Filed: Jun. 9, 2015

Related U.S. Application Data
(60) Provisional application No. 62/009,560, filed on Jun. 9, 2014.

(51) Int. Cl. H01R 13/405

(52) U.S. Cl. CPC H01R 13/405

(57) ABSTRACT

An in-line power connector used for connecting power cables. The connector includes a conductive portion having a first section and a second section. The first section has a first cable receiving recess which is dimensioned to receive and terminate a first cable therein to provide a mechanical and electrical connection between the first cable receiving recess and the first cable. The second section has a second cable receiving recess which is dimensioned to receive and terminate a second cable therein to provide a mechanical and electrical connection between the second cable receiving recess and the second cable. The connector also includes an insulation portion provided over a portion of the conductive portion. The insulation portion has an insulative first section with a first insulation receiving area and an insulative second section with a second insulation receiving area.

### FIELD OF THE INVENTION

The present invention is directed to a power connector for electrically and mechanically connecting two wires or cables. In particular, the invention is directed to an overmolded power connector which electrical connects large gauge wires/cables.

### BACKGROUND OF THE INVENTION

A wide variety of power connectors exist for use today, depending upon the environment and application for which they are intended. Examples of these applications may be found in various environments, such as in manufacturing where equipment is utilized having high power demands or in electrical and power systems for automobiles, construction equipment, agricultural equipment or in aircrafts.

These types of power connectors generally connect a large gauge wire or cable to a device, such as, but not limited to, a battery or other piece of equipment. The cables must then extend from the connectors, often times in confined spaces. As these are generally large gauge wire or cables, is becomes difficult to bend or maneuver the cables in such limited spaces.

It would, therefore, be beneficial to provide a power connector and system which is easy to manufacture and easy to install and which allows for use of the large gauge cables in confined spaces. In particular, it would be beneficial to provide a power connector and system which allows for the cable to be bent without the need for a substantial radius of curvature.

### SUMMARY OF THE INVENTION

An embodiment is directed to a power connector used for electrically and mechanically connected power cables. The connector includes a conductive portion and an insulation portion.

The conductive portion has a first portion, a second portion and a transition portion, with the first portion extending at an angle between 0 degrees and 180 degrees from the second portion. The insulation portion is overmolded over the conductive portion.

An embodiment is directed to an in-line power connector used for electrically and mechanically connecting power cables. The connector includes a conductive portion and an overmolded insulation portion. The conductive portion has a first section for receiving a first cable therein and a second section for receiving a second cable therein. The overmolded insulation portion is overmolded over the conductive portion.

An embodiment is directed to an in-line power connector used for connecting power cables. The connector includes a conductive portion having a first section and a second section. The first section has a first cable receiving recess which is dimensioned to receive and terminate a first cable therein to provide a mechanical and electrical connection between the first cable receiving recess and the first cable. The second section has a second cable receiving recess which is dimensioned to receive and terminate a second cable therein to provide a mechanical and electrical connection between the second cable receiving recess and the second cable. The connector also includes an insulation portion provided over a portion of the conductive portion. The insulation portion has an insulative first section with a first insulation receiving area and an insulative second section with a second insulation receiving area.

An embodiment is directed to an in-line power connector used for electrically and mechanically connecting power cables. The connector includes a conductive portion having a first section for receiving a first cable therein and a second section for receiving a second cable therein. The conductive portion is formed from a single, continuous piece of conductive material. The connector also includes an insulation portion which is overmolded over the conductive portion. The insulation portion is a molded single, continuous piece of insulation material.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative embodiment of a connector according to the present invention.

FIG. 2 is a perspective view of a conductive portion of the connector of FIG. 1.

FIG. 3 is a front plan view of the conductive portion of FIG. 2.

FIG. 4 is a cross-section view of the conductive portion of FIG. 2, taken along line 4-4 of FIG. 3.

FIG. 5 is a perspective view of an insulated overmolded portion of the connector of FIG. 1.

FIG. 6 is a front plan view of the insulated portion of FIG. 5.

FIG. 7 is a cross-section view of the insulated portion of FIG. 5, taken along line 7-7 of FIG. 5.

FIG. 8 is a perspective view of the connector of FIG. 1 with cable terminated thereto.

FIG. 9 is a cross-sectional view of the connector of FIG. 9, taken along its longitudinal axis.

### DETAILED DESCRIPTION OF THE INVENTION

The present invention will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that spatially relative terms, such as “top”, “upper”, “lower” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “over” other elements or features would then be oriented “under” the other elements or features. Thus, the exemplary term “over” can encompass both an orientation of over and under. The device may be otherwise oriented (rotated 90 degrees or at other orientations) and the spatially relative descriptors used herein interpreted accordingly.

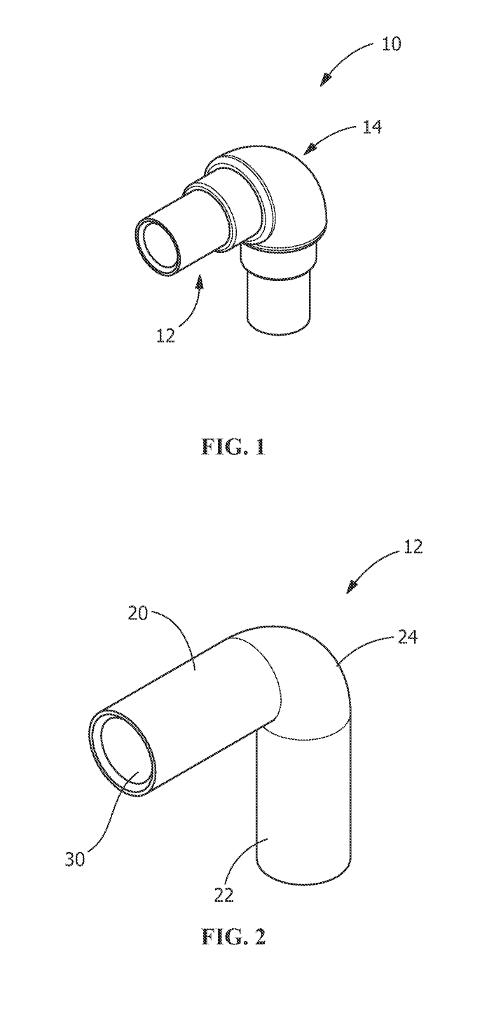

As shown in the illustrative embodiment of FIG. 1, an in-line power connector 10 includes a conductive portion 12 and an insulation portion 14 which is overmolded over the conductive portion 12. The conductive portion 12 can be made of any conductive material which is environmentally friendly and which can be crimped to a wire/cable. Such conductive materials include, but are not limited to copper, tin plated copper, brass. The insulation portion 14 is made from any material which is not conductive, which provides sufficient insulation, and which can be overmolded. Such insulation materials include, but are not limited to nylon, Valox, PVC.

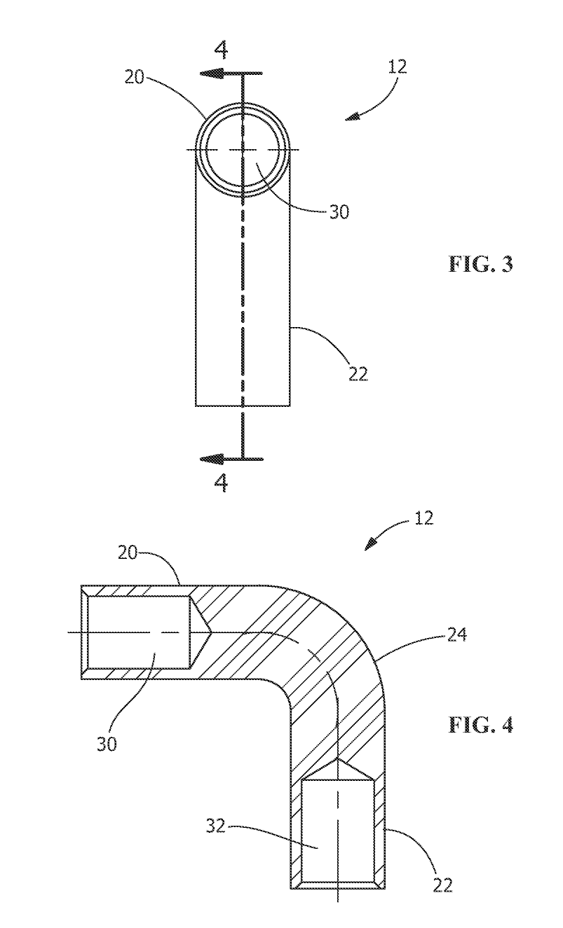

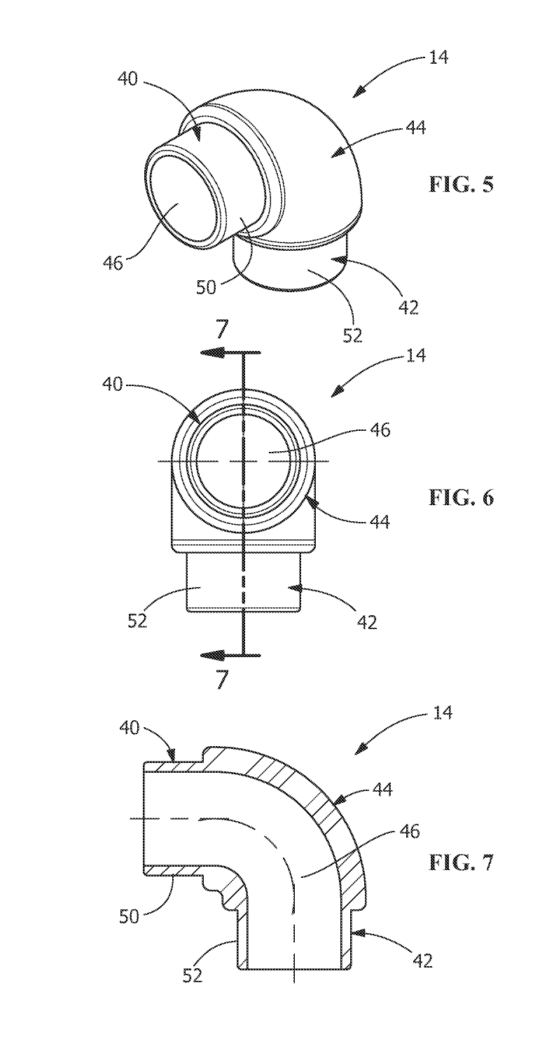

Referring to FIGS. 2 through 5, the conductive portion 12, which is formed from a single, continuous piece of conductive material, includes a first conductive section 20 and a conductive second section 22. A conductive transition section 24 extends between the first section 20 and the second section 22. In the illustrative embodiment shown, the transition section 24 has a 90 degree bend, such that the longitudinal axis of the first section 20 is essentially perpendicular to the longitudinal axis of the second section 22. However, the transitions section 24 can connect the first section 20 and the second section 22 at any angle between 0 degrees and 180 degrees.

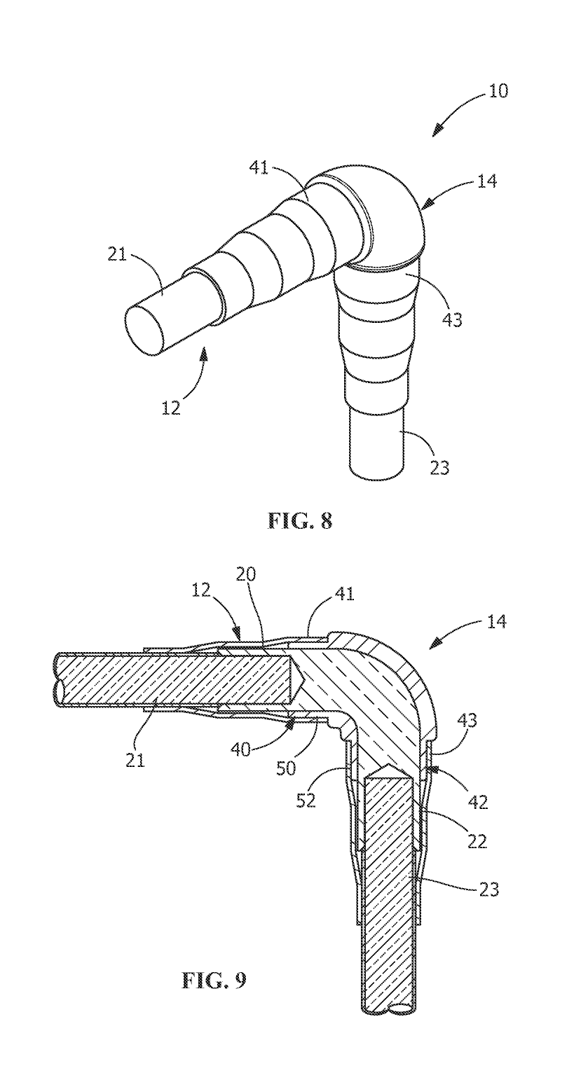

First section 20 has a cable receiving recess 30 which is dimensioned to receive a cable or wire 21 (FIGS. 8 and 9) therein. The cable receiving recess 30 can be dimensioned to receive wires/cable of different gauges or power conductor size, including, but not limited to 262 MCM, 313 MCM, 373 MCM, 444 MCM, 535 MCM, 646 MCM, 777 MCM, 929 MCM, and 1111 MCM. The wires/cables 21 are inserted into the cable receiving recess 30 and terminated thereto to provide a mechanical and electrical connection between the cable receiving recess 30 and the wire/cable. Such termination may be accomplished by crimping or other methods known in the industry.

Second section 22 has a cable receiving recess 32 which is dimensioned to receive a cable or wire 23 (FIGS. 8 and 9) therein. The cable receiving recess 32 can be dimensioned to receive wires/cable of different gauges or power conductor size, including, but not limited to 262 MCM, 313 MCM, 373 MCM, 444 MCM, 535 MCM, 646 MCM, 777 MCM, 929 MCM, and 1111 MCM. The wires/cables 23 are inserted into the cable receiving recess 32 and terminated thereto to provide a mechanical and electrical connection between the cable receiving recess 32 and the wire/cable. Such termination may be accomplished by crimping or other methods known in the industry.

With wires/cables 21, 23 properly inserted and terminated in cable receiving recesses 30, 32, the conductive portion 12 provides an electrically conductive pathway to place the wires/cables 21, 23 in electrical engagement.

Referring to FIGS. 2 through 5, the insulation portion 14, which is molded in a single, continuous piece from insulation material, includes a first insulative section 40 and a second insulative section 42. An insulative transition section 44 extends between the first section 40 and the second section 42. In the illustrative embodiment shown, the transition section 44 has a 90 degree bend, such that the longitudinal axis of the first section 40 is essentially perpendicular to the longitudinal axis of the second section 42. However, the transitions section 44 can connect the first section 40 and the second section 42 at any angle between 0 degrees and 180 degrees. The insulation portion 14 has an interior passageway 46 which is dimensioned to receive the conductive portion 12 therein. In the embodiment shown, the insulation portion 14 is overmolded over the conductive portion 12 and therefore, the interior passageway 46 conforms to the shape of the outside surfaces of the conductive portion 12.

First section 40 has an insulation receiving area 50 which has a smaller outside diameter than the transition section 44. The insulation receiving area 50 is dimensioned to receive a heat shrink sleeve 41 (FIGS. 8 and 9) thereon. The heat shrink sleeve 41 extends from and overlaps the insulation of the cable/wire 21, the first section 20 of the conductive portion 12 and extends to and overlaps the insulation receiving area 50, thereby providing proper insulation to the exposed area of the cable and the first section 20 of the conductive portion 12 when the cable/wire is properly terminated thereto.

Second section 42 has an insulation receiving area 52 which has a smaller outside diameter than the transition section 44. The insulation receiving area 52 is dimensioned to receive a heat shrink sleeve 42 (FIGS. 8 and 9) thereon. The heat shrink sleeve 43 extends from and overlaps the insulation of the cable/wire 23, the second section 22 of the conductive portion 12 and extends to and overlaps the insulation receiving area 52, thereby providing proper insulation to the exposed area of the cable and the second section 22 of the conductive portion 12 when the cable/wire is properly terminated thereto.

As heat shrink material and methods of applying the heat shrink are known in the industry, a further explanation will not be provided. Other types of insulation materials and methods may be used to insulate the exposed areas of the cables and the first section and second sections 20, 22 without departing from the scope of the invention.

The power connector 10 of the present invention is a stand alone connector which can be manufactured using standard manufacturing machinery. In addition, the termination of the wire/cable to the power connector 10 can be done using known crimping techniques and tooling.

The power connector 10 can be used in many applications. One illustrative application is when a larger diameter cable is used in a confined space and must bent to accommodate the termination at each end of the cable. In this application, the cable cannot be easily bent at 90 degrees, as the thickness and stiffness of the cable will prevent such bending or will require a large radius of curvature, which cannot be accomplished in a confined area. Therefore, in order to allow the cable to be used in such an application, the cable is cut and the power connector 10 is installed thereon. The use of the connector 10 in-line with the cable allows the cable structure or system to be bent in a confined space at the angle required, thereby allowing the cable to be used in the space provided.

In the past, many connectors used with large gauge cables/wires have been made using lead. However, the present invention uses a more environmentally friendly material, thereby minimizing the issues involved with lead components and waste stream issues at the end of the life cycle of the cables. The power connector 10 of the present invention provides this benefit without adversely affecting the performance of the cable.

While the invention has been described with reference to an illustrative embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments and methods are therefore to be considered in all respects as illustrative and not restrictive, the scope of the invention being defined by the appended claims, and not limited to the foregoing description or embodiments.

1. An in-line power connector used for electrically and mechanically connecting power cables, the connector comprising:
a conductive portion having a first section for receiving a first cable therein and a second section for receiving a second cable therein;
an overmolded insulation portion overmolded over the conductive portion.

2. The in-line power connector of claim 1, wherein a first longitudinal axis of the first section of the conductive portion extends at an angle of between 0 degrees and 180 degrees relative to a second longitudinal axis of the second portion.

3. The in-line power connector of claim 2, wherein the first longitudinal axis of the first section of the conductive portion extends at an angle of approximately 90 degrees relative to the second longitudinal axis of the second portion.

4. The in-line power connector of claim 1, wherein the conductive portion is formed from a single, continuous piece of conductive material.

5. The in-line power connector of claim 1, wherein a transition section extends between the first section and the second section, the transition section has a bend of between 0 degrees and 180 degrees.

6. The in-line power connector of claim 1, wherein the first section has a first cable receiving recess which is dimensioned to receive and terminate the first cable therein to provide a mechanical and electrical connection between the first cable receiving recess and the first cable.

7. The in-line power connector of claim 6, wherein the second section has a second cable receiving recess which is dimensioned to receive and terminate the second cable therein to provide a mechanical and electrical connection between the second cable receiving recess and the second cable.

8. The in-line power connector of claim 7, wherein first cable receiving recess is dimensioned to receive cables of 262 MCM, 313 MCM, 373 MCM, 444 MCM, 535 MCM, 646 MCM, 777 MCM, 929 MCM, or 1111 MCM size.

9. The in-line power connector of claim 8, wherein second cable receiving recess is dimensioned to receive cables of 262 MCM, 313 MCM, 373 MCM, 444 MCM, 535 MCM, 646 MCM, 777 MCM, 929 MCM, or 1111 MCM size.

10. The in-line power connector of claim 1, wherein the insulation portion is a molded single, continuous piece of insulation material.

11. The in-line power connector of claim 1, wherein the insulation portion has an insulative first section, an insulative second section and an insulative transition section which extends between the insulative first section and the insulative second section.

12. The in-line power connector of claim 11, wherein the insulation portion has interior passageway which is dimensioned to receive the conductive portion therein.

13. The in-line power connector of claim 11, wherein the insulative first section has a first insulation receiving area which has a smaller outside diameter than the insulative transition section.

14. The in-line power connector of claim 13, wherein the first insulation receiving area is dimensioned to receive a first heat shrink sleeve thereon, the first heat shrink sleeve extends from and overlaps the insulation of the first cable and extends to and overlaps the first insulation receiving area to provide proper insulation to an exposed area of the first cable and the first section of the conductive portion when the cable is properly terminated to the conductive portion.

15. The in-line power connector of claim 14, wherein the insulative second section has a second insulation receiving area which has a smaller outside diameter than the insulative transition section.

16. The in-line power connector of claim 15, wherein the second insulation receiving area is dimensioned to receive a second heat shrink sleeve thereon, the second heat shrink sleeve extends from and overlaps the insulation of the second cable and extends to and overlaps the second insulation receiving area to provide proper insulation to an exposed area of the second cable and the second section of the conductive portion when the cable is properly terminated to the conductive portion.

17. An in-line power connector used for connecting power cables, the connector comprising:
a conductive portion having a first section and a second section, the first section has a first cable receiving recess which is dimensioned to receive and terminate a first cable therein to provide a mechanical and electrical connection between the first cable receiving recess and the first cable, the second section has a second cable receiving recess which is dimensioned to receive and terminate a second cable therein to provide a mechanical and electrical connection between the second cable receiving recess and the second cable;
an insulation portion provided over a portion of the conductive portion, the insulation portion has an insulative first section with a first insulation receiving area and an insulative second section with a second insulation receiving area.

18. The in-line power connector of claim 1, wherein a transition section extends between the first section and the second section, the transition section has a bend of between 0 degrees and 180 degrees.

19. An in-line power connector used for electrically and mechanically connecting power cables, the connector comprising:
a conductive portion having a first section for receiving a first cable therein and a second section for receiving a second cable therein, the conductive portion being formed from a single, continuous piece of conductive material;
an overmolded insulation portion which is overmolded over the conductive portion, the insulation portion being a molded single, continuous piece of insulation material.

20. The in-line power connector of claim 1, wherein a transition section extends between the first section and the second section, the transition section has a bend of between 0 degrees and 180 degrees.
